(19) United States
(12) Patent Application Publication
(10) Pub. No.: US 2006/0076702 A1
(43) Pub. Date: Apr. 13, 2006

(54) Method of manufacturing a casing of an electronic product with surface decoration thereon

(76) Inventors: Fu-Chi Tsai, Taipei Hsien (TW); Po-Yi Lin, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/959,040

(22) Filed: Oct. 7, 2004

(51) Int. Cl. B29C 45/14; B29C 43/18

(52) U.S. Cl. 264/132; 264/259; 264/320; 264/153

(57) ABSTRACT

A method of manufacturing a casing of an electronic product with surface decoration thereon has a step of designing a decorative image, a step of printing a decorative layer on a film, and a step of injection molding. The decorative image is designed by using a computer. The decorative image is transformed into a decorative layer and the decorative layer is printed on a film by using a computer and a printer connected with each other. The casing of an electronic product with surface decoration thereof is obtained by applying in-mold decoration and injection molding technology, which combines injection material with the film.

### BACKGROUND OF THE INVENTION

1. Field of the Invention

The present invention relates to a method of manufacturing a casing of an electronic product with surface decoration thereon, and more particularly, to a method of manufacturing a casing of an electronic product with surface decoration thereon that applies in-mold decoration and injection molding technology.

2. Background of the Invention

Electronic products are used widely and have become an indispensable part of our lives. For example, portable electronic products, such as modern cellular phones, notebooks, hand-writing-type computers, personal digital assistants, multi-function portable drivers, or electronic learning dictionaries, have small sizes and many functions, and have become essential and practical tools in our lives and work. All such devices have decorative effects and fancy signs. Moreover, because imaginative designs are popular and the sense of individualized interests is raised, the key factors that attract consumers to choose electronic products are not only their functions and efficiencies but also their exterior designs. Therefore, manufacturers add decorative layers on casings of electronic products to provide various visual effects.

A conventional method of manufacturing a casing of an electronic product with surface decoration thereon applies in-mold decoration and injection molding technology to dispose a decorative layer on a casing. The decorative layer is printed on a film by coating, or offset printing and serigraphy. Then the film is combined with an injection material by injection molding to obtain a casing of an electronic product with surface decoration.

However, if the decorative layer is formed by coating, coloring and baking are alternately applied, which is time-consuming. Also, errors in the dimensions of the decorative layer easily occur and the process cannot provide a precise quality.

If the decorative layer is formed by offset printing and serigraphy, the manufacturing efficiency is improved, but the costs of plates are expensive, making impossible to provide a market demand for both smaller quantity and diverse types to satisfy consumers' changes of their interests. Also, the decorative layer has a grain surface, and the quality is not fine enough. Furthermore, there are problems of adjustment and positioning when printing, which are complex and increase defective products.

Accordingly, as discussed above, the conventional method of manufacturing a casing of an electronic product with surface decoration thereon still has some drawbacks that could be improved. The present invention aims to resolve the drawbacks in the prior art.

### SUMMARY OF INVENTION

The primary object of the invention is therefore to specify a method of manufacturing a casing of an electronic product with surface decoration thereon, so that the design of surface decoration is easy and manufacturing of the casing is simple to reduce manufacturing costs thereof, and so that surface decoration is diverse and the quality thereof is improved to provide more types of exterior designs thereof for consumers.

According to the invention, the object is achieved via a method of manufacturing a casing of an electronic product with surface decoration thereon. The surface decoration comprises designing a decorative image, printing a decorative layer on a film, and injection molding. Designing a decorative image includes providing a unit of computerized image processing and printing equipment, and using the computerized image processing and printing equipment to design a decorative image. Printing the decorative layer on the film includes providing a film and using the computerized image processing and printing equipment to transform the decorative image into a decorative layer and to print the decorative layer on the film. The injection molding includes providing a set of injection molding molds and injection material, placing the film into the set of injection molding molds, and injecting the injection material into the set of injection molding molds to combine the injection material with the film to obtain a casing of an electronic product with surface decoration thereon.

By using the computerized image processing and printing equipment, it is very easy to design a decorative image for surface decoration of a casing, to transform the decorative image directly into a decorative layer, and to print the decorative layer on a film, so as to improve the quality of the decorative layer. Then by using injection molding technology to combine injection material with the film, reducing costs for manufacturing a casing of an electronic product with surface decoration thereon is simple, so as to provide more types of exterior designs of the casing.

According to the invention, the object is achieved via another method of manufacturing a casing of an electronic product with surface decoration thereon comprising providing a decorative picture, printing a decorative layer on a film and injection molding. Providing the decorative picture includes providing a draft with a decorative picture thereon. Printing the decorative layer on the film includes providing a unit of optical image catching and printing equipment and a film, using the optical image catching and printing equipment to transform the decorative picture on the draft into a decorative layer and to print the decorative layer on the film. The injection molding includes providing a set of injection molding molds and injection material, placing the film into the set of injection molding molds, and injecting the injection material into the set of injection molding molds to combine the injection material with the film to obtain a casing of an electronic product with surface decoration thereon.

By using an optical image catching and printing equipment, it is very easy to catch a decorative picture on a draft, to transform the decorative picture directly into a decorative layer, and to print the decorative layer on a film, so as to improve the quality of the decorative layer. Then by using injection molding technology to combine injection material with the film, reducing costs for manufacturing a casing of an electronic product with surface decoration thereon is simple, so as to provide more types of exterior designs of the casing.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention which will be described hereinafter and which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a flow chart of a first embodiment of a method of manufacturing a casing of an electronic product with surface decoration thereon of the present invention;

FIG. 2 is a schematic, cross-sectional view of a film provided in a method of manufacturing a casing of an electronic product with surface decoration thereon of the present invention;

FIG. 3 is a schematic, cross-sectional view of a decorative layer printed on a film in a method of manufacturing a casing of an electronic product with surface decoration thereon of the present invention;

FIG. 4 is a schematic, cross-sectional view of a protective layer attached to a decorative layer on a film in a method of manufacturing a casing of an electronic product with surface decoration thereon of the present invention;

FIG. 5 is a schematic, cross-sectional view showing a set of pressing and shaping molds compresses a film to form it into a three dimensional shape in a method of manufacturing a casing of an electronic product with surface decoration thereon of the present invention;

FIG. 6 is a schematic, cross-sectional view showing a set of punching and shearing machine punching and shearing a film to obtain a predetermined specification thereof in a method of manufacturing a casing of an electronic product with surface decoration thereon of the present invention;

FIG. 7 is a schematic, cross-sectional view showing injection material injected into a set of injection molding molds for combination with a film in a method of manufacturing a casing of an electronic product with surface decoration thereon of the present invention; and

FIG. 8 is a flow chart of a second embodiment of a method of manufacturing a casing of an electronic product with surface decoration thereon of the present invention.

### DETAILED DESCRIPTION OF THE EMBODIMENTS

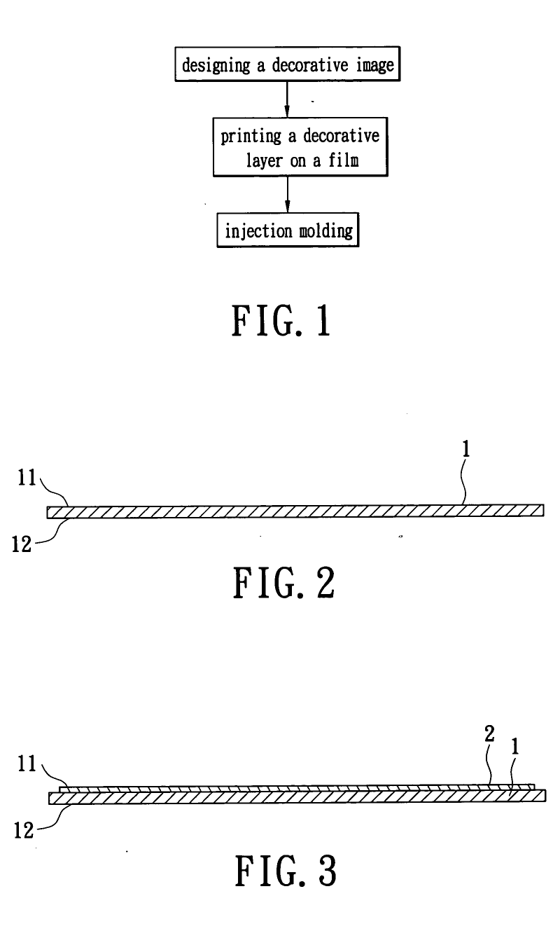

FIG. 1 illustrates a first embodiment of the present invention. The present invention provides a method of manufacturing a casing of an electronic product with surface decoration thereon. A decorative image is designed. Computerized image processing and printing equipment, such as a computer and a laser-type printer connected with each other, or a computer and an inkjet-type printer connected with each other, are provided. The computerized image processing and printing equipment are used to design a decorative image, such as, for example, drawings, written words, photos, trademarks, signatures, or graffiti.

The decorative layer is then printed on a film. A film 1 (see FIG. 2) is provided, such as a plastic film made of PC material. The film 1 has a first surface 11 and a second surface 12. The computerized image processing and printing equipment are used to transform the decorative image into a decorative layer 2 and to print the decorative layer 2 on the film 1 (see FIG. 3). In this embodiment, the decorative layer 2 is printed on the first surface 11 of the film 1.

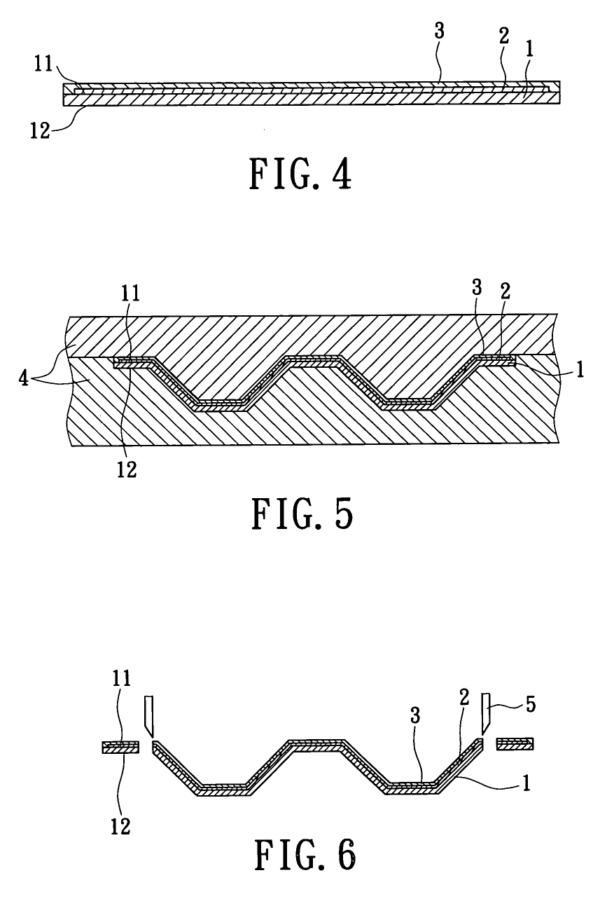

As shown in FIG. 4, after printing the decorative layer 2 on the film 1, the method of the first embodiment further comprises a step of attaching a protective layer 3 on the decorative layer 2, so as to firmly arrange the decorative layer 2.

As shown in FIG. 5, after printing the decorative layer 2 on the film 1, the method of the first embodiment further comprises a step of compressing the film 1. A set of pressing and shaping molds 4 is provided, the film 1 is placed in the set of pressing and shaping molds 4, and the film 1 is compressed into a three dimensional shape for use as the casing of an electronic product, such as a keypad of a cellular phone.

As shown in FIG. 6, after printing the decorative layer 2 on the film 1 and compressing the film 1 into a three dimensional shape, the method of the first embodiment further comprises a step of punching and shearing the film 1. A punching and shearing machine 5 is provided, and the punching and shearing machine 5 punches and shears the film 1 to obtain a predetermined specification thereof, such as a proper outline and some assembling holes, so as to provide for later assembly steps.

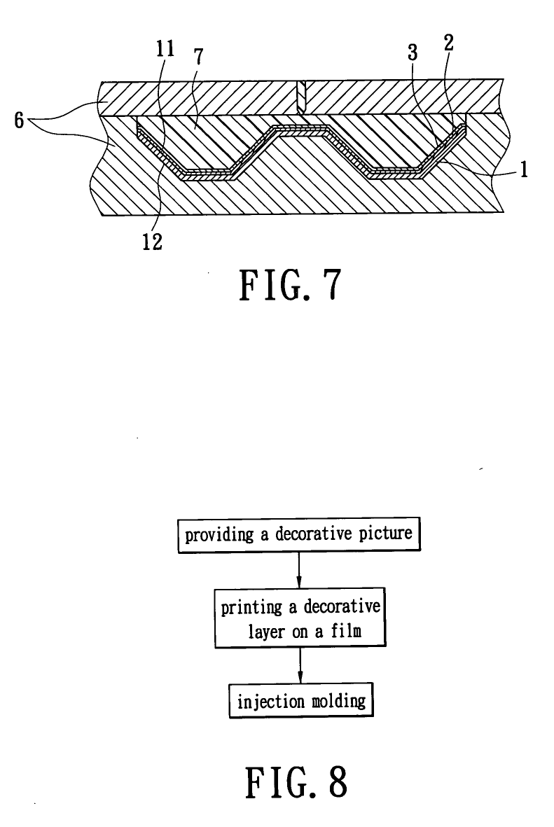

Injection molding is then performed. A set of injection molding molds 6 and injection material 7 (see FIG. 7) are provided. The film 1 is placed into the set of injection molding molds 6, and the injection material 7 is injected into the set of injection molding molds 6 to combine the injection material 7 with the first surface 11 of the film 1 and obtain a casing of an electronic product with surface decoration thereon. The injection material 7 may also combine with the second surface 12 of the film 1.

Because the drawing and processing ability of the computer is powerful, it is very easy to design and edit the decorative image, so that the method of the first embodiment can provide casings of electronic products with unique and individualized decorative layers for consumers, such as using personal photos or signatures as decorative images. Therefore, the method of the first embodiment can satisfy the market need for diverse casings of electronic products, such as a limited quantity of cellular phones with a special surface decoration thereon. Moreover, by using the laser-type printer or the inkjet-type printer to print the decorative layer on the film, the decorative layer is much finer and much more realistic, and the quality of colors and lines thereof are improved. By applying the in-mold decoration and injection molding technology, the manufacturing of the casing of an electronic product with surface decoration thereon is much simpler, so that the costs thereof are reduced.

FIG. 8 illustrates a second embodiment of the present invention. The present invention provides a method of manufacturing a casing of an electronic product with surface decoration thereon. A decorative picture is provided, in the form of a draft with a decorative picture thereon, such as the decorative image mentioned in the first embodiment. A decorative layer on a film is printed on the film. Optical image catching and printing equipment is provided, such as a photocopier, and a film 1 (see FIG. 2). The optical image catching and printing equipment are used to transform the decorative picture on the draft into a decorative layer 2 and to print the decorative layer 2 on the film 1 (see FIG. 3). After printing the decorative layer 2 on the film 1, as illustrated in the first embodiment, the method of the second embodiment may further comprise a step of attaching a protective layer 3 on the decorative layer 2 (see FIG. 4), a step of compressing the film 1 into a three dimensional shape (see FIG. 5), and a step of punching and shearing the film 1 to obtain a predetermined specification thereof (see FIG. 6).

Injection molding is then performed. A set of injection molding molds 6 and injection material 7 (see FIG. 7) are provided. The film 1 is placed into the set of injection molding molds 6, and the injection material 7 is injected into the set of injection molding molds 6 to combine the injection material 7 with the film 1 to obtain a casing of an electronic product with surface decoration thereon.

It is very easy to catch the decorative picture of the draft and to have fine and precise quality of colors and lines by using the photocopier. Therefore, the second embodiment can obtain the same efficiency as the first embodiment.

As indicated above, the method of manufacturing a casing of an electronic product with surface decoration thereon of the present invention has the following advantages:

(1) By using a computerized image processing and printing equipment, it is very easy to design a decorative image for surface decoration of a casing, to transform the decorative image directly into a decorative layer, and to print the decorative layer on a film, so as to improve the quality of the decorative layer. Then by using injection molding technology to combine injection material with the film, costs for manufacturing a casing of an electronic product with surface decoration thereon are easily reduced, so as to provide more types of exterior designs of the casing.

(2) By using an optical image catching and printing equipment, it is very easy to catch a decorative picture on a draft, to transform the decorative picture directly into a decorative layer, and to print the decorative layer on a film, so as to improve the quality of the decorative layer. Then by using injection molding technology to combine injection material with the film, manufacturing of a casing of an electronic product with surface decoration thereon is simple to reduce manufacturing costs thereof, so as to have more types of exterior designs of the casing.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A method of manufacturing a casing of an electronic product with surface decoration thereon, comprising:
designing a decorative image, including providing a computerized image processing and printing equipment, and using the computerized image processing and printing equipment to design a decorative image;
printing a decorative layer on a film, including providing a film, using the computerized image processing and printing equipment to transform the decorative image into a decorative layer and to print the decorative layer on the film; and
injection molding, including providing a set of injection molding molds and injection material, placing the film into the set of injection molding molds, and injecting the injection material into the set of injection molding molds to combine the injection material with the film to obtain a casing of an electronic product with surface decoration thereon.

2. The method as claimed in claim 1, further comprising attaching a protective layer on the decorative layer after printing the decorative layer on the film.

3. The method as claimed in claim 1, further comprising providing a set of pressing and shaping molds, placing the film into the set of pressing and shaping molds, and compressing the film into a three dimensional shape after printing the decorative layer on the film.

4. The method as claimed in claim 1, further comprising providing a punching and shearing machine, the punching and shearing machine punching and shearing the film to obtain a predetermined specification thereof after printing the decorative layer on the film.

5. The method as claimed in claim 1, wherein the computerized image processing and printing equipment is a computer and a laser-type printer connected with each other, or a computer and an inkjet-type printer connected with each other.

6. A method of manufacturing a casing of an electronic product with surface decoration thereon, comprising:
providing a decorative picture, including providing a draft with a decorative picture thereon;
printing a decorative layer on a film, including providing an optical image catching and printing equipment and a film, and using the optical image catching and printing equipment to transform the decorative picture on the draft into a decorative layer and to print the decorative layer on the film; and
injection molding, including providing a set of injection molding molds and injection material, placing the film into the set of injection molding molds, and injecting the injection material into the set of injection molding molds to combine the injection material with the film to obtain a casing of an electronic product with surface decoration thereon.

7. The method as claimed in claim 6, further comprising attaching a protective layer on the decorative layer after printing the decorative layer on the film.

8. The method as claimed in claim 6, further comprising providing a set of pressing and shaping molds, placing the film into the set of pressing and shaping molds, and compressing the film into a three dimensional shape after printing the decorative layer on the film.

9. The method as claimed in claim 6, further comprising providing a punching and shearing machine, the punching and shearing machine punching and shearing the film to obtain a predetermined specification thereof after printing the decorative layer on the film.

10. The method as claimed in claim 6, wherein the optical image catching and printing equipment is a photocopier.
